(19) United States
(12) Patent Application Publication
(10) Pub. No.: US 2011/0026430 A1
(43) Pub. Date: Feb. 3, 2011

(54) METHOD AND APPARATUS FOR DETECTING A CHANNEL CONDITION FOR A WIRELESS COMMUNICATION DEVICE

(75) Inventors: Youngjae Kim, Santa Clara, CA (US); Feng Lu, Santa Clara, CA (US); Anil Kumar Goteti, Evanston, IL (US); Jonathan Sidi, Santa Clara, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/512,224

(22) Filed: Jul. 30, 2009

(51) Int. Cl. H04B 17/00; H04L 12/26

(52) U.S. Cl. 370/253; 455/67.7; 375/228

(57) ABSTRACT

A method for detecting a channel condition for a wireless communication device is provided. The method includes measuring a plurality of power levels as received by the wireless communication device; determining a metric based on the plurality of power level measurements; and generating a high-speed fading indication signal based on the metric. An apparatus for performing the method is also disclosed herein.

### BACKGROUND

I. Field

The following description relates generally to communication systems, and more particularly, to a method and apparatus for detecting a channel condition for a wireless communication device.

II. Background

Mobile wireless communication systems are affected by propagation anomalies that produce extreme variations in both amplitude and apparent frequency in the signals received by a mobile terminal or user equipment. This phenomenon, known as fading, is exacerbated by terrain or buildings that cause multipath reception issues. Fading can be loosely classified as fast or slow. Slow fading may be a phenomenon that occurs over a length of time, and over several symbol intervals, while fast, or high-speed, fading generally refers to variations that are time related, such as within symbol intervals. The fading can affect one or more channels, and high-speed fading channel conditions are very disruptive to user equipment.

However, if the user equipment can detect a high-speed fading channel condition, it can utilize that information and adaptively adjust its system parameters accordingly. Further, for example, the user equipment can use it for improving channel estimation.

One approach of detecting fading channel conditions is to observe fluctuations of input power over a period of time and determine if there is a great enough variance to indicate fade. Simply observing the input power fluctuation during any time period, however, is not sufficient because intermittent (non-continuous) data transmission would result in a variation of the input power even when the channel is stable. Therefore, distinguishing high-speed fading from effects caused by scheduling of intermittent data transmission or channel usage is an important aspect of an implementation of high-speed fading detection.

Consequently, it would be desirable to address one or more of the deficiencies described above.

### SUMMARY

According to various aspects, the subject innovation relates to apparatus and/or methods for high-speed fading detection that enables a wireless receiver to adapt to dynamic channel conditions.

According to an aspect of the disclosure, a method of detecting a channel condition for a wireless communication device is provided. The method includes measuring a plurality of power levels as received by the wireless communication device; determining a metric based on the plurality of power level measurements; and generating a high-speed fading indication signal based on the metric.

According to yet another aspect of the disclosure, an apparatus for detecting a channel condition for a wireless communication device is provided. The apparatus includes means for measuring a plurality of power levels as received by the wireless communication device; means for determining a metric based on the plurality of power level measurements; and means for generating a high-speed fading indication signal based on the metric.

According to yet another aspect of the disclosure, an apparatus for detecting a channel condition for a wireless communication device is provided. The apparatus includes a memory storing a plurality of power level measurements; and, a processing system configured to determine a metric based on the plurality of power level measurements; and generate a high-speed fading indication signal based on the metric.

According to yet another aspect of the disclosure, a computer-program product for detecting a channel condition for a wireless communication device is disclosed. The computer-program product includes a machine-readable medium encoded with instructions executable by a processor to cause the processor to measure a plurality of power levels as received by the wireless communication device; determine a metric based on the plurality of power level measurements; and generate a high-speed fading indication signal based on the metric.

According to yet another aspect of the disclosure, a wireless communications device is disclosed. The wireless communications device includes a receiver configured to receive radio frequency transmissions comprising various power levels. The communications device further includes a processing system configured to measure a plurality of power levels as received by the wireless communication device; determine a metric based on the plurality of power level measurements; and generate a high-speed fading indication signal based on the metric.

Although particular aspects are described herein, many variations and permutations of these aspects fall within the scope of the disclosure. Whereas some benefits and advantages of the preferred aspects are mentioned, the scope of the disclosure is not intended to be limited to particular benefits, uses, or objectives. Rather, aspects of the disclosure are intended to be broadly applicable to different wireless and wire line technologies, system configurations, networks, and transmission protocols, some of which are illustrated by way of example in the figures and in the following Detailed Description. The detailed description and drawings are merely illustrative of the disclosure rather than limiting, the scope of the disclosure being defined by the appended claims and equivalents thereof.

### BRIEF DESCRIPTION OF THE DRAWINGS

These and other sample aspects of the disclosure will be described in the detailed description that follow, and in the accompanying drawings, wherein:

FIG. 1 is a diagram of a wireless communications network configured in accordance with one aspect of the disclosure;

FIG. 2 is a block diagram of a wireless communication apparatus as configured in accordance with an aspect of the disclosure that may be used in the wireless communications network of FIG. 1, within which a high-speed fading detector may be included;

FIG. 3 is a block diagram of a high-speed fading detection system as configured in accordance with an aspect of the disclosure that may be used in the wireless communication apparatus of FIG. 2;

FIG. 4 is a block diagram of a gain determination circuit as configured in accordance with an aspect of the disclosure that may be used in the high-speed fading detection system of FIG. 3;

FIG. 5 is a plot of an example of an adaptive gain control (AGC) signal output by the gain determination circuit of FIG. 4 for a first intermittent data transmission scheduling pattern;

FIG. 6 is a plot of the AGC signal output by the gain determination circuit of FIG. 4 for a second intermittent data transmission scheduling pattern;

FIG. 7 is a plot of the AGC signal output by the gain determination circuit of FIG. 4 under a high-speed fading condition;

FIG. 8 is a flow chart of a first mode of operation of the high-speed fading detection system of FIG. 3 configured in accordance with an aspect of the disclosure;

FIG. 9 is a flow chart of a second mode of operation of the high-speed fading detection system of FIG. 3 configured in accordance with an aspect of the disclosure;

FIG. 10 is a block diagram illustrating an example of a hardware configuration for a processing system in a wireless node in the wireless communications network of FIG. 1; and

FIG. 11 is a block diagram illustrating an apparatus for detecting a channel condition for a wireless communication device.

In accordance with common practice, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

In an aspect of the disclosure, a high-speed fading detection system monitors and logs a level of input power, such as the input power level at a receiver in a mobile station, to detect a high-speed fading condition. The high-speed fading detection system can determine an occurrence of high-speed fading as opposed to power fluctuations caused by intermittent data transmissions. Through the detection of high-speed fading, user equipment may to adapt to the dynamic channel conditions more intelligently. In an aspect, the input power level is monitored within a minimum duration of a decodable packet. For example, for a High-Speed Downlink Packet Access (HSDPA) system, which is a third generation (3G) mobile telephony communications protocol in the High-Speed Packet Access (HSPA) family that allows networks based on the Universal Mobile Telecommunications System (UMTS) HSDPA system, the minimum duration of a decodable packet is the duration of a sub-frame.

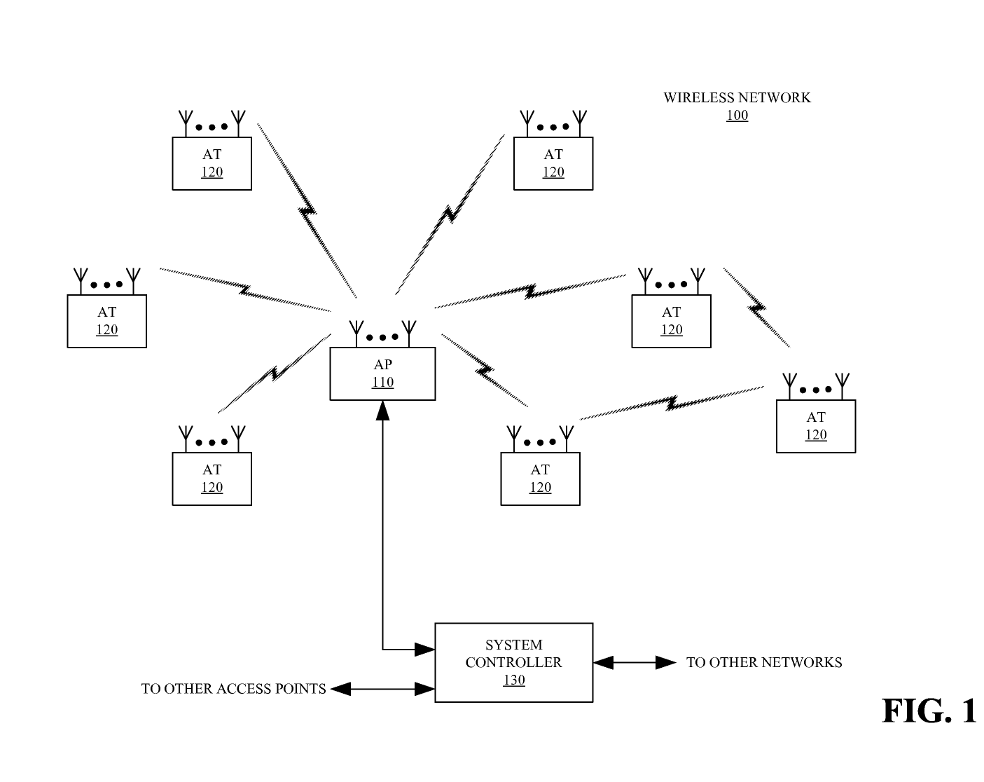

Several aspects of a wireless network 100 that includes devices that uses the high-speed fading detection system will now be presented with reference to FIG. 1. The wireless network 100 is shown with several wireless nodes, generally designated as nodes 110 and 120. Each wireless node is capable of receiving and/or transmitting signals using radio frequency. In the detailed description that follows, for downlink communications the terms “base station” or “access point” are used to designate a transmitting node and the terms “mobile station”, “user equipment” or “mobile station” are used to designate a receiving node, whereas for uplink communications these terms are conversely used to refer to a receiving node and a transmitting node, respectively. However, those skilled in the art will readily understand that other terminology or nomenclature may be used for a base station and/or mobile station. By way of example, a base station may be referred to as an access point, a base transceiver station, a station, a terminal, a node, a mobile station acting as an access point, or some other suitable terminology. A mobile station may be referred to as a user equipment, a user terminal, an mobile station, a subscriber station, a station, a wireless device, a terminal, a node, or some other suitable terminology. The various concepts described throughout this disclosure are intended to apply to all suitable wireless nodes regardless of their specific nomenclature.

The wireless network 100 may support any number of base stations distributed throughout a geographic region to provide coverage for mobile stations 120. A system controller 130 may be used to provide coordination and control of the base stations, as well as access to other networks (e.g., Internet) for the mobile stations 120. For simplicity, one base stations 110 is shown. A base station is generally a fixed terminal that provides backhaul services to mobile stations in the geographic region of coverage. However, the base station may be mobile in some applications. A mobile station, which may be fixed or mobile, utilizes the backhaul services of a base station or engages in peer-to-peer communications with other mobile stations. Examples of mobile stations include a telephone (e.g., cellular telephone), a laptop computer, a desktop computer, a Personal Digital Assistant (PDA), a digital audio player (e.g., MP3 player), a camera, a game console, or any other suitable wireless node.

A wireless node, whether a base station or mobile station, may be implemented with a protocol that utilizes a layered structure that includes a physical (PHY) layer that implements all the physical and electrical specifications to interface the wireless node to the shared wireless channel, a MAC layer that coordinates access to the shared wireless channel, and an application layer that performs various data processing functions including, by way of example, speech and multimedia codecs and graphics processing. Additional protocol layers (e.g., network layer, transport layer) may be required for any particular application. In some configurations, the wireless node may act as a relay point between a base station and mobile station, or two mobile stations, and therefore, may not require an application layer. Those skilled in the art will be readily able to implement the appropriate protocol for any wireless node depending on the particular application and the overall design constraints imposed on the overall system.

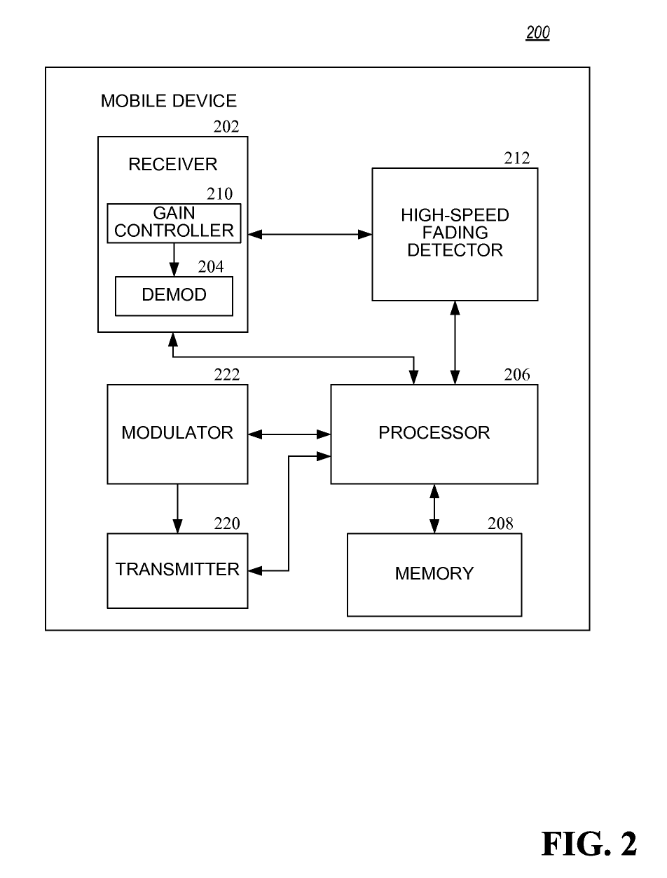

FIG. 2 is an illustration of a mobile device 200 that facilitates receiving and processing messages received over a wireless network such as the wireless network 100 of FIG. 1. The mobile device 200 includes a receiver 202 that receives a signal from, for instance, a receive antenna (not shown), performs typical actions on (e.g., filters, amplifies, downconverts, etc.) the received signal, and digitizes the conditioned signal to obtain samples. Receiver 202 can comprise a demodulator 204 that can demodulate received symbols and provide them to a processor 206 for channel estimation. The processor 206 can be a processor dedicated to analyzing information received by the receiver 202 and/or generating information for transmission by a transmitter 220, a processor that controls one or more components of the mobile device 200, and/or a processor that both analyzes information received by the receiver 202, generates information for transmission by the transmitter 220, and controls one or more components of the mobile device 200.

The mobile device 200 can additionally comprise a memory 208 that is operatively coupled to the processor 206 and that can store data to be transmitted, received data, information related to available channels, data associated with analyzed signal and/or interference strength, information related to an assigned channel, power, rate, or the like, and any other suitable information for estimating a channel and communicating via the channel. The memory 208 can additionally store protocols and/or algorithms associated with estimating and/or utilizing a channel (e.g., performance based, capacity based, etc.).

It will be appreciated that the data store (e.g., the memory 208) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 208 of the subject systems and methods is intended to comprise, without being limited to, these and any other suitable types of memory.

### Modulator 222

The mobile device 200 can further comprise a gain controller 210 that adjusts the received input signals before providing them to the demodulator 204. The gain controller 210 can be further coupled to a high-speed fading detector 212 that uses the signals generated from the gain controller 210 and determine when the mobile device 200 is experiencing a high-speed fading condition. The high-speed fading detector 212 can provide an indication that the mobile device 200 is experiencing high-speed fading to the processor 206.

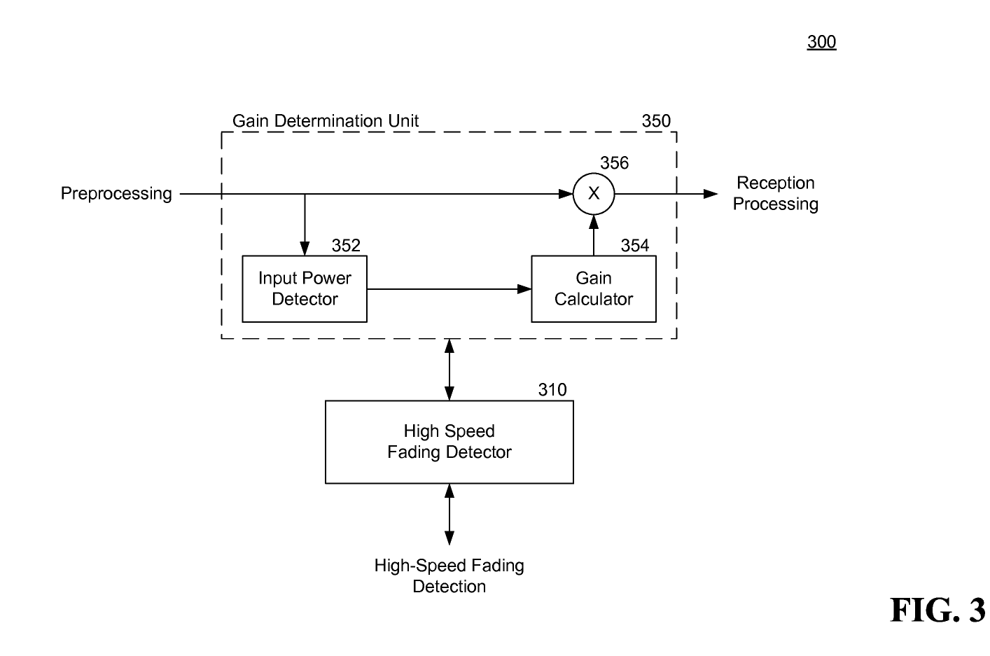

FIG. 3 illustrates a high-speed fading detection system 300 configured in accordance with an aspect of the disclosure that includes a high-speed fading detector 310 and a gain determination unit 350. The gain determination unit 350 includes an input power detector 352 and a gain calculator 354 coupled with a mixer 356. The output of the gain determination unit 350 is sent to a downstream processing module, such a demodulator (e.g., demodulator 204). In an aspect of the disclosure, the output of the gain determination unit 350 is designed to be proportional to the steady-state received power. Thus, when the communication channel is stable, the value the output is fairly constant in time and is a fair estimate of received signal strength. In contrast, when channel conditions are changing, which may be due to a fading condition or fluctuation in the signal based on data transmission, the received power signal is not stable and thus the output of the gain determination unit 350 will fluctuate as it changes its output signal in an attempt to converge to a steady-state value. In an aspect of the disclosure, the high-speed fading detector 310 uses the output of the gain determination unit 350 to determine the existence of high-speed fading because the converging behavior of the output of the gain determination unit 350 changes based on whether the fluctuation is because of intermittent scheduling or because of high-speed fading.

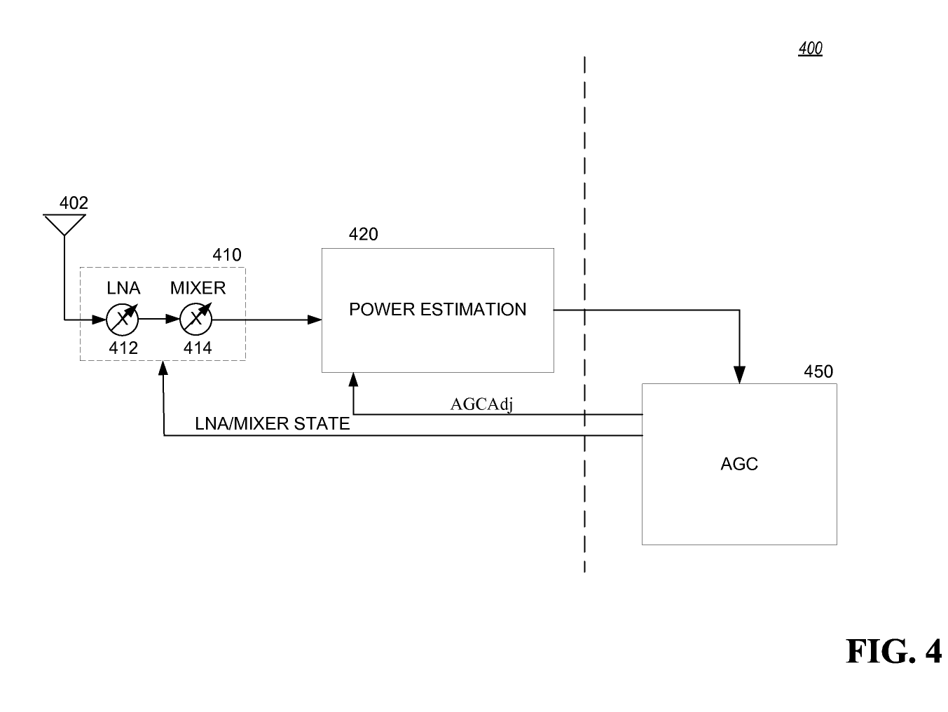

FIG. 4 illustrates a receiver input power gain determination unit 400 configured in accordance with an aspect of the disclosure that may be used to implement the gain determination unit 350 of FIG. 3. The receiver input power gain determination unit 400 includes an Adaptive Gain Controller (AGC) 450 that controls a power estimation module 420 that receives and amplifies the received signal from a front end gain stage 410.

The front end gain stage 410 includes a Low-Noise Amplifier (LNA) 412 couple to an antenna 402 to receive and amplify the signals received therefrom before passing it to a mixer 414. The mixer provides 414 a digital signal to the rest of the system, including the power estimation module 420 that is coupled to the AGC 450.

The AGC 450 sets a gain of the power estimation module 420 and states of the front end gain stage 410 based upon power measurements made by the power estimation unit 420. in one aspect of the disclosure, both fine grain and coarse grain approaches are addressed by the AGC 450. In an aspect of the disclosure, the AGCAdj signal output from the AGC 450 is designed to be proportional to the steady-state received power. Thus, when the channel is stable, this value is fairly constant in time, which provides a good estimate of received signal strength. In contrast, when channel conditions are changing, the AGCAdj signal is not stable but is changed by the AGC 450 in an attempt to converge to a steady-state value. In an aspect of the disclosure, the pattern of variation of the AGCAdj signal as output from the AGC 450 is used to detect high-speed fading because the converging behavior of the AGCAdj signal is different in the cases of intermittent scheduling and high-speed fading. In the former case, the AGCAdj signal converges after a short period while it does not in the latter case where there is high-speed fading. Therefore, the power fluctuation caused by high-speed fading condition can be distinguished from that caused by the intermittent scheduling by monitoring rxAGCAdj.

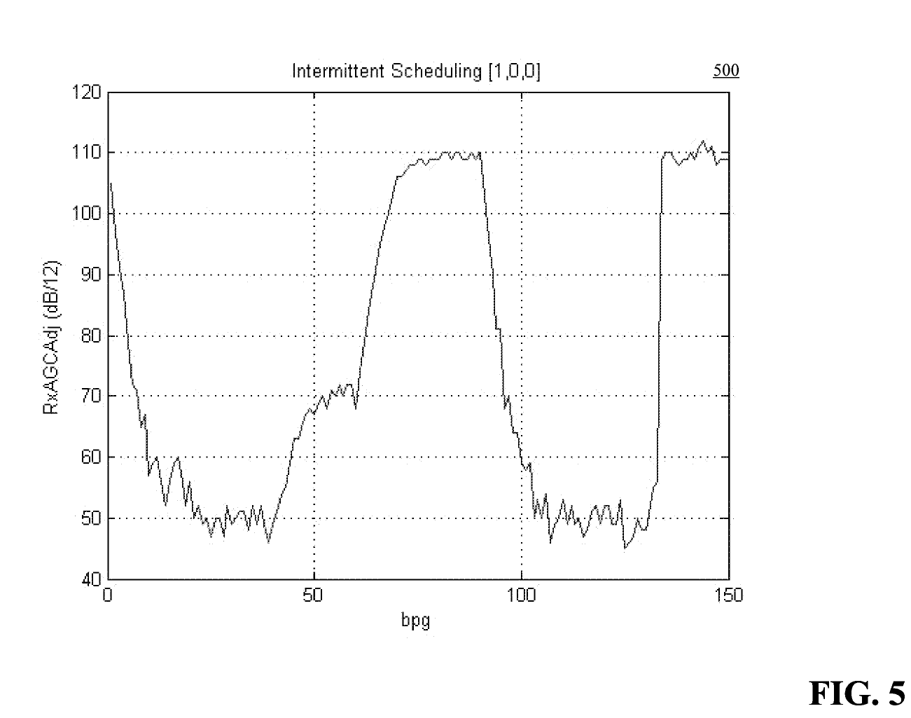

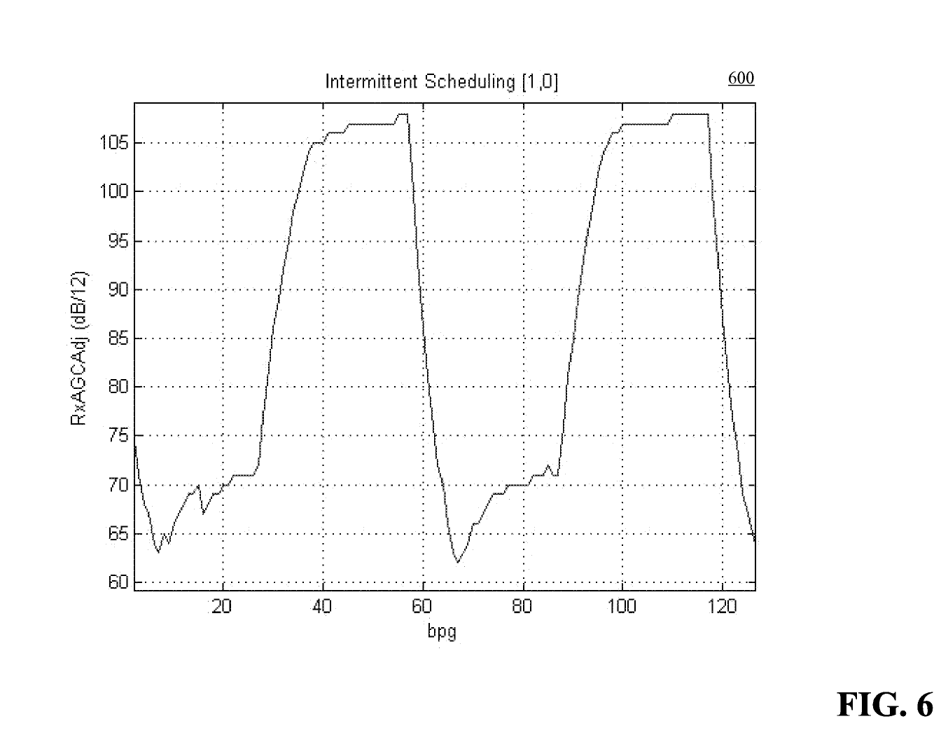

FIGS. 5 and 6 illustrate the output signals for the AGC 450 for a first and second intermittent data transmission patterns, respectively. In an aspect of the disclosure, the values are plotted across a horizontal scale measured by Group Chip Unit (GCU or “GCU”)—change figures as well-Block Processing Group (BPG or “bpg”) units. In the example provided, each BPG represents approximately 256 pulses. Each pulse is also referred to as a chip, which is a pulse of a direct-sequence spread spectrum (DSSS) code, such as a pseudo-noise code sequence used in direct-sequence code division multiple access (CDMA) channel access techniques.

In FIGS. 5 and 6, a pattern of [b1, b2, bᵢ, . . . , bₙ] represents a data being transmitted during every sub-frame i where bᵢ is equal to “1”. Thus, a pattern of [1, 0, 0] in FIG. 5 represents that data is transmitted during the first sub-frame time period, which in the illustrated example is 30 BPGs, and no data is transmitted during the last two sub-frames. In an aspect, no data is transmitted using a discontinuous transmission (DTX) method, which is a method of momentarily powering-down, or muting, a mobile or portable wireless telephone set when there is no input (e.g., voice) to the set. DTX optimizes the overall efficiency of a wireless voice communications system. In FIG. 5, it should be noted that the received power is high for approximately 30 BPGs and suddenly drops because DTX follows. When the data is transmitted again, the received power suddenly increases but this is not immediately reflected in the AGCAdj signal because it takes time to converge. After the signal converges, it can be seen that the AGCAdj signal is fairly stable. As illustrated, the whole pattern repeats every three sub-frames (i.e., the pattern repeats every 90 BPGs). In FIG. 6, a similar pattern can be observed but the pattern repeats every 60 BPGs because the transmission pattern is [1,0].

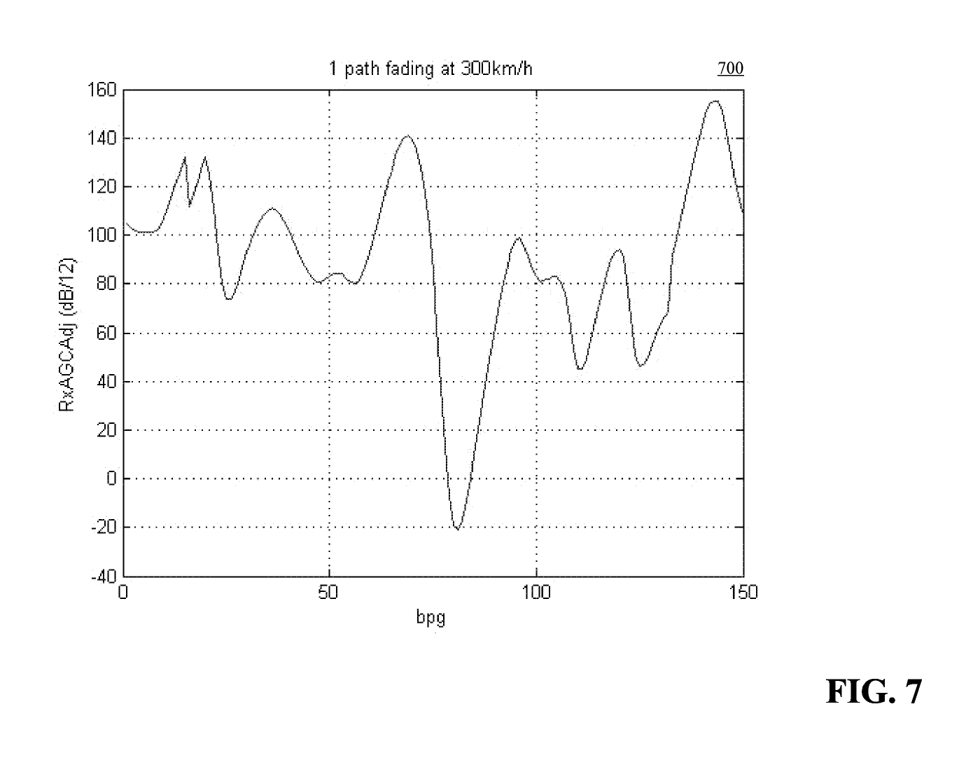

In addition to the first two cases, which illustrates intermittent data transmission scheduling in additive white Gaussian noise (AWGN) with the transmission pattern of [1,0,0] and [1,0], a third case is shown in FIG. 7, which illustrates the output signal from the AGC 450 under a high-speed fading channel condition where the mobile is moving away from the base station at a speed of 300 km/h. As illustrated, during high speed fading, the AGCAdj signal continuously varies and no convergence behavior is observed because the channel is changing rapidly.

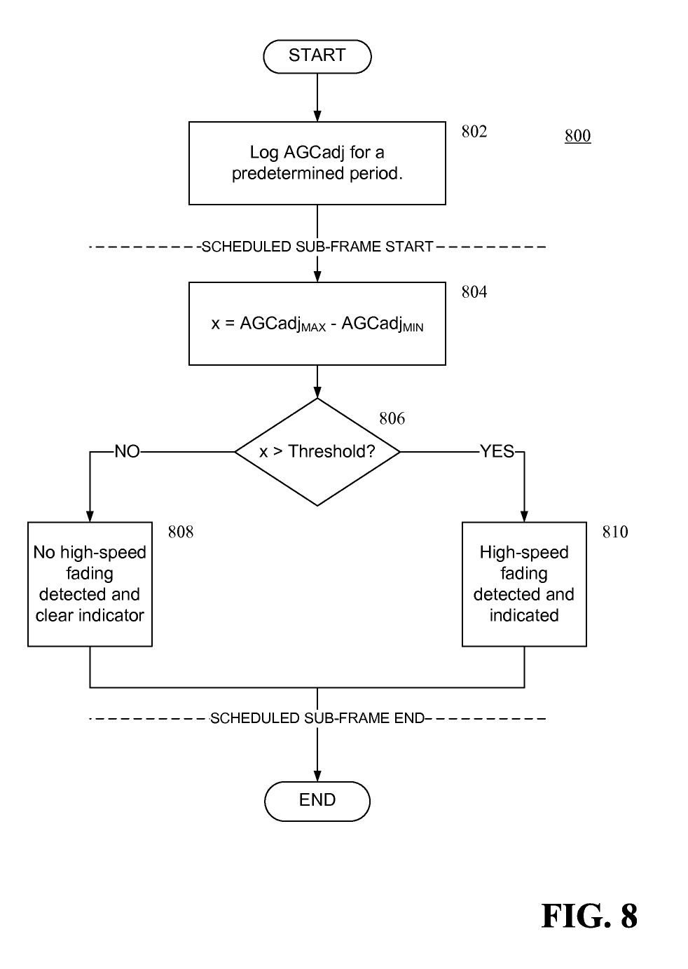

FIG. 8 illustrates a high-speed fading detection process 800 that may be implemented by the high-speed fading detector 310 of FIG. 3, where an example of the various aspects of the disclosure is applied to an HSDPA environment. In step 802, a log of the AGCadj signal is recorded. Then, in step 804, a difference between a maximum and minimum value of the AGCAdj signal values in the last Z BPGs is determined:

x=AGCadj_{MAX}−AGCadj_{MIN},

where AGCadj_{MAX} and AGCadj_{MIN} are the largest and smallest values, respectively, of the AGCadj signal measured during the last Z BPGs, where one example value of Z is 10. In an aspect of the disclosure, the difference in step 804 is determined every scheduled sub-frame. In step 806, if the difference is greater than a threshold value, where in one example value of the threshold is 4, then a high-speed fading event is occurring and operation continues with step 810, where this condition is indicated. In an aspect of the disclosure, a high-speed fading flag can be set. In step 806, if alternatively the difference is not greater than the threshold value, then no high-speed fading event is occurring and in step 808, any previously set high-speed fading flag is removed. In an aspect of the disclosure, a high-speed detector flag can be reset.

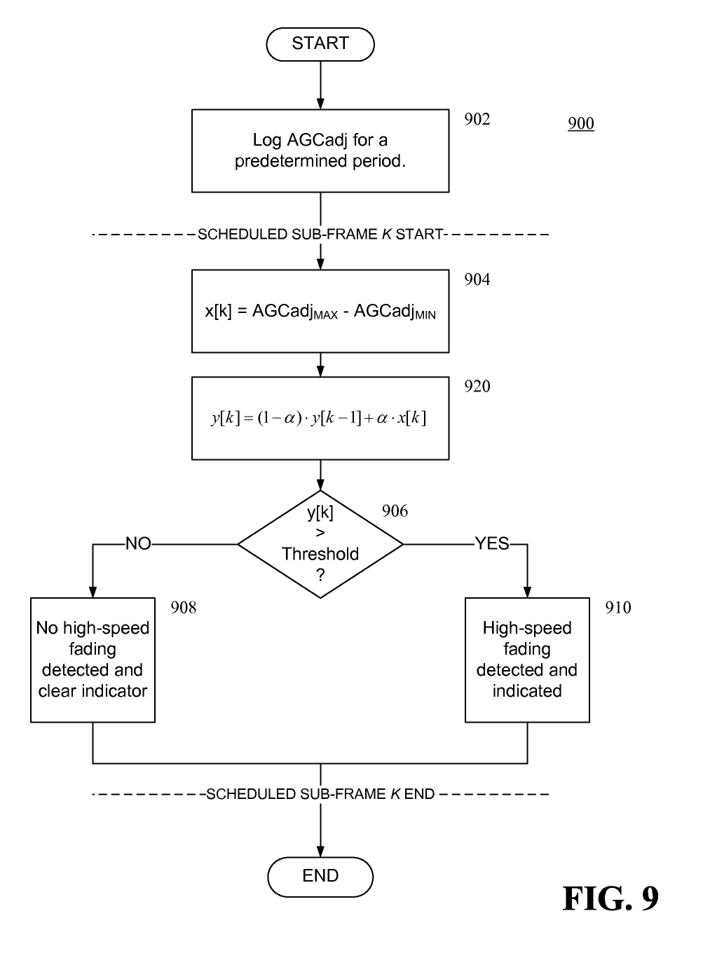

FIG. 9 illustrates a second high-speed fading detection process 900 that may be implemented by the high-speed fading detector 310 of FIG. 3, where in step 902, a log of the AGCadj signal is recorded. Then, in step 904, a difference between a maximum and minimum value of the AGCAdj signal values in the last Z BPGs for the particular sub-frame is determined:

x[k]=AGCadj_{MAX}−AGCadj_{MIN},

where AGCadj_{MAX} and AGCadj_{MIN} are the largest and smallest values, respectively, of the AGCadj signal measured during the last Z BPGs, and k is a sub-frame index. In an aspect of the disclosure, the difference in step 904 is determined every scheduled sub-frame. Operation then continues with step 920.

In step 920, to improve the performance of the process 900 in a noisy environment (e.g., to increase the robustness of the operation in a noisy channel), a filter operation is then applied to the difference:

y[k]=(1−α)·y[k−1]+αx[k],

where y[k] is the filtered difference and the variable α is a empirically chosen value, which in the example is 0.5. In an aspect of the disclosure, a single-tap infinite impulse response (IIR) filter can be used as a filter for the signal difference. In another aspect of the disclosure, other filters or operations may be used in addition to or in place of the disclosed IIR filter. Further, one or more filtering or other operations may use other inputs or even be placed in another portion of the processing chain.

In step 906, if the filtered difference is greater than a threshold value, which in the example is 4, then a high-speed fading event is occurring and operation continues with step 910, where this condition is indicated. In an aspect of the disclosure, a high-speed fading flag can be set. Alternatively, if in step 906 it is determined that the filtered difference is not greater than the threshold value, then no high-speed fading event is occurring and operation continues with step 908, where any previously set high-speed fading condition is removed. In an aspect of the disclosure, a high-speed detector flag can be reset.

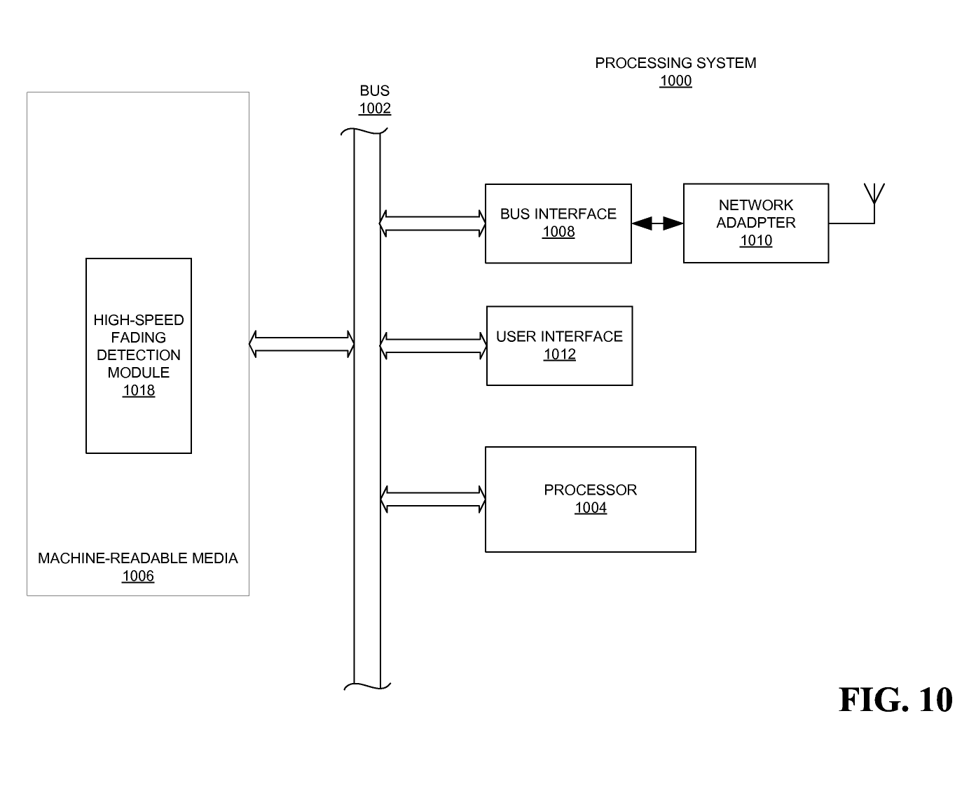

FIG. 10 is a conceptual diagram illustrating an example of a hardware configuration for a processing system 1000 in a wireless node. In this example, the processing system 1000 may be implemented with a bus architecture represented generally by bus 1002. The bus 1002 may include any number of interconnecting buses and bridges depending on the specific application of the processing system 1000 and the overall design constraints. The bus links together various circuits including a processor 1004, machine-readable media 1006, and a bus interface 1008. The bus interface 1008 may be used to connect a network adapter 1010, among other things, to the processing system 1000 via the bus 1002. The network interface 1010 may be used to implement the signal processing functions of the PHY layer. In the case of an mobile station 110 (see FIG. 1), a user interface 1012 (e.g., keypad, display, mouse, joystick, etc.) may also be connected to the bus. The bus 1002 includes a clock line (CLK) to communicate a clock. The bus 1002 may also link various other circuits such as timing sources, peripherals, voltage regulators, power management circuits, and the like, which are well known in the art, and therefore, will not be described any further.

The processor 1004 is responsible for managing the bus and general processing, including the execution of software stored on the machine-readable media 1008. The processor 1008 may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof The machine-readable may be embodied in a computer-program product. The computer-program product may comprise packaging materials.

In the hardware implementation illustrated in FIG. 10, the machine-readable media 1006 is shown as part of the processing system 1000 separate from the processor 1004. However, as those skilled in the art will readily appreciate, the machine-readable media 1006, or any portion thereof, may be external to the processing system 1000. By way of example, the machine-readable media 1006 may include a transmission line, a carrier wave modulated by data, and/or a computer product separate from the wireless node, all which may be accessed by the processor 1004 through the bus interface 1008. Alternatively, or in addition to, the machine readable media 1004, or any portion thereof, may be integrated into the processor 1004, such as the case may be with cache and/or general register files.

The processing system 1000 may be configured as a general-purpose processing system with one or more microprocessors providing the processor functionality and external memory providing at least a portion of the machine-readable media 1006, all linked together with other supporting circuitry through an external bus architecture. Alternatively, the processing system 1000 may be implemented with an ASIC (Application Specific Integrated Circuit) with the processor 1004, the bus interface 1008, the user interface 1012 in the case of an mobile station), supporting circuitry (not shown), and at least a portion of the machine-readable media 1006 integrated into a single chip, or with one or more FPGAs (Field Programmable Gate Array), PLDs (Programmable Logic Device), controllers, state machines, gated logic, discrete hardware components, or any other suitable circuitry, or any combination of circuits that can perform the various functionality described throughout this disclosure. Those skilled in the art will recognize how best to implement the described functionality for the processing system 1000 depending on the particular application and the overall design constraints imposed on the overall system.

The machine-readable media 1006 is shown with a number of software modules. The software modules include instructions that when executed by the processor 1004 cause the processing system 1000 to perform various functions. Each software module may reside in a single storage device or distributed across multiple storage devices. By way of example, a software module may be loaded into RAM from a hard drive when a triggering event occurs. During execution of the software module, the processor 1004 may load some of the instructions into cache to increase access speed. One or more cache lines may then be loaded into a general register file for execution by the processor 1004. When referring to the functionality of a software module below, it will be understood that such functionality is implemented by the processor 1004 when executing instructions from that software module. In one aspect, a module 1018 for detecting a high-speed fading condition is provided.

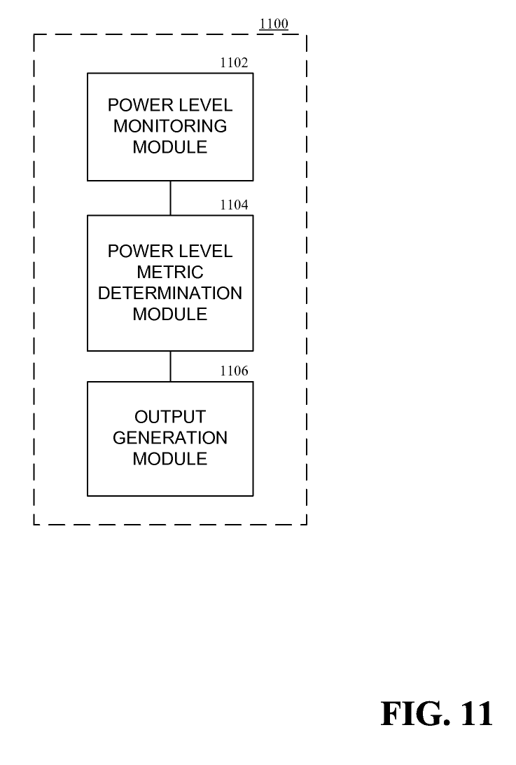

FIG. 11 is a block diagram illustrating an exemplary apparatus 1100 for detecting a channel condition for a wireless communication device having various modules operable to determine a high-speed fading condition. A power level monitoring module 1102 is used for measuring a plurality of power levels as received by the wireless communication device. A power level metric determination module 1104 is configured to determine a metric based on the plurality of power level measurements. An output generation module 1106 is configured to generate a high-speed fading indication signal based on the metric.

Various aspects described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media may include, but are not limited to, magnetic storage devices, optical disks, digital versatile disk, smart cards, and flash memory devices.

The disclosure is not intended to be limited to the preferred aspects. Furthermore, those skilled in the art should recognize that the method and apparatus aspects described herein may be implemented in a variety of ways, including implementations in hardware, software, firmware, or various combinations thereof. Examples of such hardware may include ASICs, Field Programmable Gate Arrays, general-purpose processors, DSPs, and/or other circuitry. Software and/or firmware implementations of the disclosure may be implemented via any combination of programming languages, including Java, C, C++, Matlab™, Verilog, VHDL, and/or processor specific machine and assembly languages.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (“IC”), an mobile station, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The method and system aspects described herein merely illustrate particular aspects of the disclosure. It should be appreciated that those skilled in the art will be able to devise various arrangements, which, although not explicitly described or shown herein, embody the principles of the disclosure and are included within its scope. Furthermore, all examples and conditional language recited herein are intended to be only for pedagogical purposes to aid the reader in understanding the principles of the disclosure. This disclosure and its associated references are to be construed as being without limitation to such specifically recited examples and conditions. Moreover, all statements herein reciting principles, aspects, and aspects of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be appreciated by those skilled in the art that the block diagrams herein represent conceptual views of illustrative circuitry, algorithms, and functional steps embodying principles of the disclosure. Similarly, it should be appreciated that any flow charts, flow diagrams, signal diagrams, system diagrams, codes, and the like represent various processes that may be substantially represented in computer-readable medium and so executed by a computer or processor, whether or not such computer or processor is explicitly shown.

It is understood that any specific order or hierarchy of steps described in the context of a software module is being presented to provide an examples of a wireless node. Based upon design preferences, it is understood that the specific order or hierarchy of steps may be rearranged while remaining within the scope of the disclosure.

Although various aspects of the disclosure have been described as software implementations, those skilled in the art will readily appreciate that the various software modules presented throughout this disclosure may be implemented in hardware, or any combination of software and hardware. Whether these aspects are implemented in hardware or software depends upon the particular application and design constraints imposed on the overall system. Skilled artisans may implement the described functionality in varying ways for each particular application, but such implementation decisions should not be interpreted as causing a departure from the scope of the disclosure.

The previous description is provided to enable any person skilled in the art to understand fully the full scope of the disclosure. Modifications to the various configurations disclosed herein will be readily apparent to those skilled in the art. Thus, the claims are not intended to be limited to the various aspects of the disclosure described herein, but is to be accorded the full scope consistent with the language of claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for detecting a channel condition for a wireless communication device comprising:
measuring a plurality of power levels as received by the wireless communication device;
determining a metric based on the plurality of power level measurements; and
generating a high-speed fading indication signal based on the metric.

2. The method of claim 1, wherein the determination comprises calculating a difference between two input power level measurements is greater than a predetermined threshold.

3. The method of claim 2, wherein the determination further comprises determining when the difference between two input power level measurements is greater than a predetermined threshold.

4. The method of claim 1, wherein the wireless communication device comprises a receiver and the power level is measured at the receiver.

5. The method of claim 1, wherein the wireless communication device comprises an amplifier and the power level is measured at the amplifier.

6. The method of claim 1, wherein the measurement comprises monitoring the input power level within a predetermined duration.

7. The method of claim 6, wherein the predetermined duration is a minimum duration of a decodable packet.

8. The method of claim 2, wherein the two input power level measurements include a highest power level measurement and a lowest power level measurement from the plurality of power level measurements and the determination comprises calculating a difference between the highest and the lowest power level measurements.

9. The method of claim 2, wherein the wireless communication device communicates via a channel comprising a plurality of frames, each frame comprising at least one sub-frame and the determination occurs each sub-frame.

10. The method of claim 2, wherein the determination comprises filtering the difference before determining when the difference is greater than the threshold.

11. The method of claim 10, wherein the filter comprises performing an infinite impulse response filter operation.

12. An apparatus for detecting a channel condition for a wireless communication device comprising:
means for measuring a plurality of power levels as received by the wireless communication device;
means for determining a metric based on the plurality of power level measurements; and
means for generating a high-speed fading indication signal based on the metric.

13. The apparatus of claim 12, wherein the determination means comprises means for calculating a difference between two input power level measurements.

14. The apparatus of claim 13, wherein the determination means further comprises means for determining when the difference between two input power level measurements is greater than a predetermined threshold

15. The apparatus of claim 12, wherein the wireless communication device comprises a receiver and the power level is measured at the receiver.

16. The apparatus of claim 12, wherein the wireless communication device comprises an amplifier and the power level is measured at the amplifier.

17. The apparatus of claim 12, wherein the measurement means comprises means for monitoring the input power level within a predetermined duration.

18. The apparatus of claim 17, wherein the predetermined duration is a minimum duration of a decodable packet.

19. The apparatus of claim 13, wherein the two input power level measurements include a highest power level measurement and a lowest power level measurement from the plurality of power level measurements and the determination means comprises means for calculating a difference between the highest and the lowest power level measurements.

20. The apparatus of claim 13, wherein the wireless communication device communicates via a channel comprising a plurality of frames, each frame comprising at least one sub-frame, and the determination means comprises means for calculating the difference during each sub-frame.

21. The apparatus of claim 13, wherein the determination means comprises means for filtering the difference before determining when the difference is greater than the threshold.

22. The apparatus of claim 21, wherein the filter means comprises means for performing an infinite impulse response filter operation.

23. An apparatus for detecting a channel condition for a wireless communication device, comprising:
a memory storing a plurality of power level measurements; and,
a processing system configured to:
determine when a metric based on the plurality of power level measurements; and
generate a high-speed fading indication signal based on the metric.

24. The apparatus of claim 23, wherein the processing system is further configured to calculate a difference between two input power level measurements.

25. The apparatus of claim 24, wherein the processing system is further configured to determine when the difference between two input power level measurements is greater than a predetermined threshold.

26. The apparatus of claim 23, wherein the wireless communication device comprises a receiver and the power level is measured at the receiver.

27. The apparatus of claim 23, wherein the wireless communication device comprises an amplifier and the power level is measured at the amplifier.

28. The apparatus of claim 23, wherein the processing system is further configured to monitor the input power level within a predetermined duration.

29. The apparatus of claim 28, wherein the predetermined duration is a minimum duration of a decodable packet.

30. The apparatus of claim 24, wherein the two input power level measurements include a highest power level measurement and a lowest power level measurement from the plurality of power level measurements and the processing system is further configured to calculate a difference between the highest and the lowest power level measurements.

31. The apparatus of claim 24, wherein the wireless communication device communicates via a channel comprising a plurality of frames, each frame comprising at least one sub-frame, and the processing system is further configured to calculate the difference during each sub-frame.

32. The apparatus of claim 24, wherein the processing system is further configured to filter the difference before determining when the difference is greater than the threshold.

33. The apparatus of claim 21, wherein the processing system is further configured to perform an infinite impulse response filter operation as part of the filter.

34. A computer-program product for detecting a channel condition for a wireless communication device, comprising:
a machine-readable medium encoded with instructions executable by a processor to cause the processor to:
measure a plurality of power levels as received by the wireless communication device;
determine a metric based on the plurality of power level measurements; and
generate a high-speed fading indication signal based on the metric.

35. A wireless communications device, comprising:
a radio receiver configured to receive radio frequency transmissions comprising various power levels; and
a processing system configured to:
measure a plurality of power levels as received by the wireless communication device;
determine a metric based on the plurality of power level measurements; and
generate a high-speed fading indication signal based on the metric.
